(19) United States
(12) Patent Application Publication
(10) Pub. No.: US 2024/0247743 A1
(43) Pub. Date: Jul. 25, 2024

(54) FLUID CONNECTION ASSEMBLY

(71) Applicant: Oetiker NY, Inc., Lancaster, NY (US)

(72) Inventors: Kari Ann Sausen, Clarence, NY (US); Thomas A. Anderson, North Tonawanda, NY (US)

(21) Appl. No.: 18/419,654

(22) Filed: Jan. 23, 2024

Related U.S. Application Data
(60) Provisional application No. 63/481,211, filed on Jan. 24, 2023.

(51) Int. Cl. F16L 37/12

(52) U.S. Cl. CPC F16L 37/1225

(57) ABSTRACT

A fluid connection assembly, including a connector body, including a first end, a second end, a first through-bore, a first radially outward facing surface including a groove, and a first radially inward facing surface, and a retainer, including a plate including a second through-bore, at least one arm, each arm of the at least one arm including a proximal end connected to the plate and a distal end, and a projection connected to the at least one arm at the distal end, the projection operatively arranged to engage the groove to connect the retainer to the connector body.

### CROSS-REFERENCE TO RELATED APPLICATIONS

This application claims the benefit under 35 U.S.C. § 119(e) of U.S. Provisional Application No. 63/481,211, filed Jan. 24, 2023, which application is incorporated herein by reference in its entirety.

### FIELD

The present disclosure relates to fluid connectors, and more particularly, to a fluid connection assembly for a refrigeration system including a connector body and a retainer that decreases the insertion force required for assembly and allows for quick assembly of components without the need for tools.

### BACKGROUND

Fluid connectors, fluid connections, and fluid connection assemblies are integral components for many applications, and especially for automotive and industrial applications. Since refrigeration systems are made up of various components such as a compressor, air cooler, condenser, receiver, evaporator or chiller, and/or suction drum, fluid must be able to travel not only within each component but also between components. Fluid predominantly moves between components via flexible or rigid hoses which connect to each component by fluid connectors. Such fluid connectors typically include a retaining clip, retaining ring clip, or snap ring carried on the connector body which is adapted to snap behind a raised shoulder of a tube when the tube is fully inserted into the connector body.

However, there are many drawbacks with current designs. During the assembly process, installation of the retaining clip onto the connector body is difficult and failure to install the retaining clip properly can jeopardize the structural integrity of the retaining clip. The force required to engage the tube into the connector body, and overcome the radial force of the retaining clip, is very large with current designs. Since the retaining clips are very thin and small, it is easy to lose them if dropped or misplaced. Some connection assembly solutions take a long time to secure and require tools for the assembly process. Moreover, current connection assembly solutions do not indicate the connection state of the assembly.

Thus, there has been a long-felt need for a fluid connection assembly for a refrigeration system including a connector body and a retainer that allows for quick assembly, disassembly, and reduces the insertion force required to assemble the fluid connector.

### SUMMARY

According to aspects illustrated herein, there is provided a fluid connection assembly, comprising a connector body, including a first end, a second end, a first through-bore, a first radially outward facing surface including a groove, and a first radially inward facing surface, and a retainer, including a plate including a second through-bore, at least one arm, each arm of the at least one arm including a proximal end connected to the plate and a distal end, and a projection connected to the at least one arm at the distal end, the projection operatively arranged to engage the groove to connect the retainer to the connector body.

In an exemplary embodiment, at least one arm of the at least one arm further comprises a second radially inward facing surface operatively arranged to engage the first radially outward facing surface, a second radially outward facing surface, and a rib extending radially from at least one of the second radially inward facing surface and the second radially outward facing surface. In an exemplary embodiment, the projection extends radially inward from the second radially inward facing surface. In an exemplary embodiment, the projection is arranged at an acute angle relative to the second radially inward facing surface. In an exemplary embodiment, the plate comprises a recess circumscribing the second through-bore. In an exemplary embodiment, the at least one arm comprises a first arm, and a second arm arranged diametrically opposed to the first arm relative to the plate. In an exemplary embodiment, the at least one arm is elastically deformable in a radial direction.

In an exemplary embodiment, the connector body further comprises a protrusion extending radially inward from the first radially inward facing surface, the protrusion forms a first surface and a second surface, and the first surface is an axially facing surface arranged perpendicular to the first radially inward facing surface. In an exemplary embodiment, the second surface is a frusto-conical surface. In an exemplary embodiment, the fluid connection assembly further comprises a tube including a shoulder, wherein the plate is operatively arranged to engage the shoulder to secure the tube to the connector body. In an exemplary embodiment, the tube comprises a flared section forming the shoulder, the flared section arranged completely within the first through-bore when the tube is secured to the connector body. In an exemplary embodiment, the shoulder is arranged to abut against the second end.

In an exemplary embodiment, the at least one arm further comprises an indentation extending axially from the distal end. In an exemplary embodiment, the at least one arm comprises a first arm, a second arm arranged diametrically opposed to the first arm relative to the plate, a third arm, and a fourth arm arranged diametrically opposed to the third arm relative to the plate. In an exemplary embodiment, the first end is arranged to be sealingly secured to a service valve body.

According to aspects illustrated herein, there is provided a fluid connection assembly, comprising a connector body, including a first end, a second end, a first through-bore, a first radially outward facing surface including a groove, a first radially inward facing surface, and a protrusion extending radially inward from the first radially inward facing surface, a tube including a shoulder operatively arranged to be inserted into the first through-bore, and a retainer, including a plate including a second through-bore, the plate operatively arranged to engage the shoulder to secured the tube in the connector body, a plurality of arms, each arm of the plurality of arms including a proximal end connected to the plate and a distal end, and a projection connected to the at least one arm at the distal end, the projection operatively arranged to engage the groove to connect the retainer to the connector body.

In an exemplary embodiment, at least one arm of the plurality of arms further comprises a second radially inward facing surface operatively arranged to engage the first radially outward facing surface, a second radially outward facing surface, and a rib extending radially from at least one of the second radially inward facing surface and the second radially outward facing surface. In an exemplary embodiment, the projection extends radially inward from the second radially inward facing surface and is arranged at an acute angle relative to the second radially inward facing surface. In an exemplary embodiment, the plate comprises a recess circumscribing the second through-bore.

According to aspects illustrated herein, there is provided a retainer for a fluid connection assembly, comprising a plate including a through-bore, a first arm connected to and extending from the plate, a second arm connected to and extending from the plate, the second arm arranged diametrically opposed to the first arm relative to the plate, a projection connected to and extending radially inward from at least one of the first arm and the second arm, and a rib extending radially from at least one of the first arm and the second arm.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1A is a front perspective view of a fluid connection assembly in a locked state.

FIG. 1B is a rear perspective view of the fluid connection assembly shown in FIG. 1A.

FIG. 2 is a front perspective exploded view of the fluid connection assembly shown in FIG. 1A.

FIG. 3 is a rear perspective view of the retainer shown in FIG. 1A.

FIG. 4 is a cross-sectional view of the fluid connection assembly taken generally along line 4-4 in FIG. 1A.

FIG. 5A is a front perspective view of a fluid connection assembly in a locked state.

FIG. 5B is a rear perspective view of the fluid connection assembly shown in FIG. 5A.

FIG. 6 is a front perspective exploded view of the fluid connection assembly shown in FIG. 5A.

FIG. 7 is a rear perspective view of the retainer shown in FIG. 5A.

FIG. 8 is a cross-sectional view of the fluid connection assembly taken generally along line 8-8 in FIG. 5A.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

It should be appreciated that the term “tube” as used herein is synonymous with hose, pipe, channel, conduit, tube end form, or any other suitable pipe flow used in hydraulics and fluid mechanics. It should further be appreciated that the term “tube” can mean a rigid or flexible conduit of any material suitable for containing and allowing the flow of a gas or a liquid.

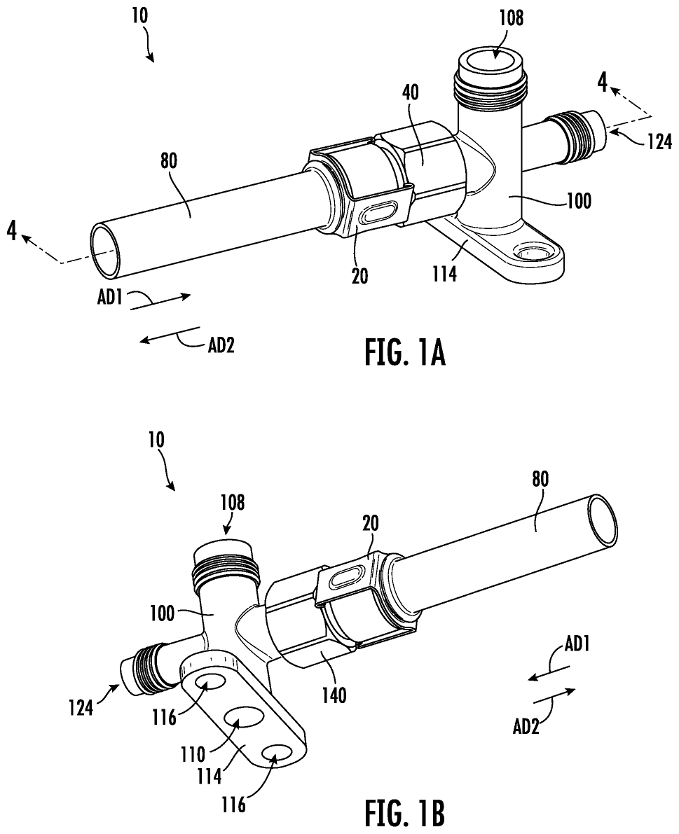

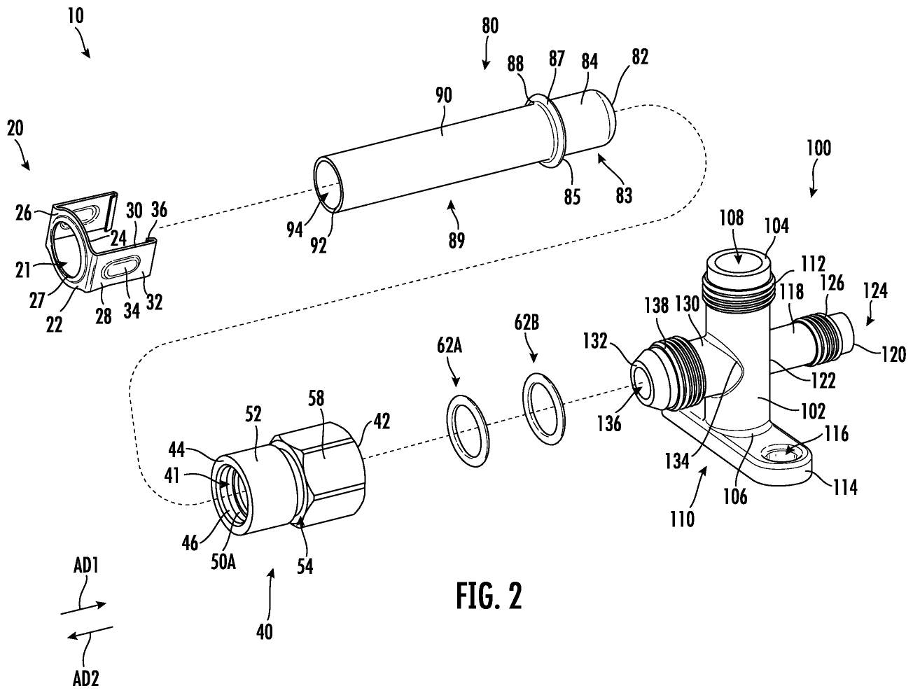

Adverting now to the figures, FIG. 1A is a front perspective view of fluid connection assembly 10 in a locked state. FIG. 1B is a rear perspective view of fluid connection assembly 10. FIG. 2 is a front perspective exploded view of fluid connection assembly 10. Fluid connection assembly 10 generally comprises connector body 40 and retainer 20. In an exemplary embodiment, fluid connection assembly 10 further comprises tube 80. In an exemplary embodiment, fluid connection assembly 10 further comprises service valve body 100.

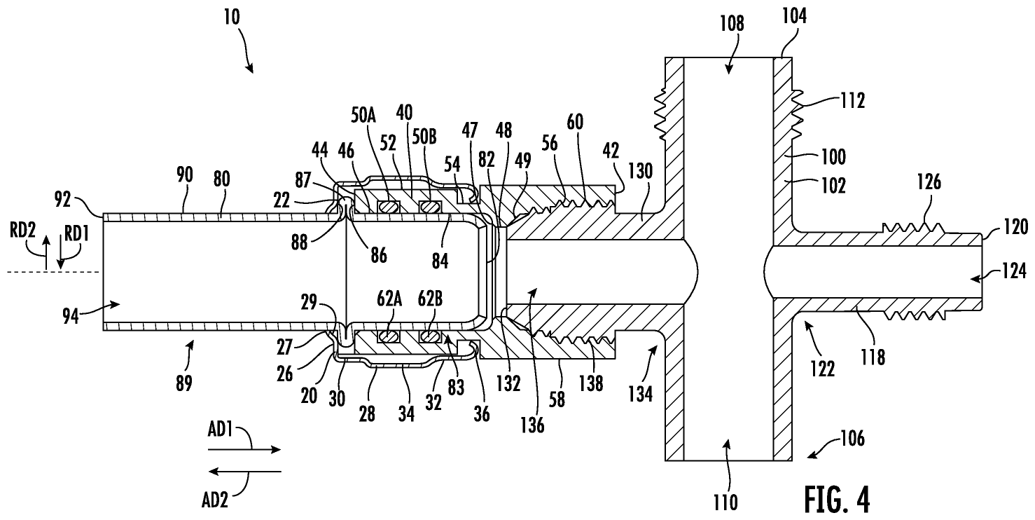

Tube 80 comprises end 82, section 83, bead or shoulder 87, section 89, end 92, and through-bore 94. Through-bore 94 extends through tube 80 from end 82 to end 92. Section 83 is arranged between end 82 and shoulder 87 and comprises radially outward facing surface 84. Radially outward facing surface 84 includes a substantially constant diameter. In an exemplary embodiment, radially outward facing surface 84 comprises a frusto-conical taper or curvilinear surface proximate end 82 (see FIG. 4). Shoulder 87 is arranged between section 83 and section 89 and comprises surface 86 and surface 88. In an exemplary embodiment, surface 86 is an axial surface facing at least partially in axial direction AD1 and surface 88 is an axial surface facing at least partially in axial direction AD2. In an exemplary embodiment, surface 86 is a frusto-conical surface extending from the radially outward facing surface of shoulder 87 radially inward in axial direction AD1. For example, surface 86 may be a linear conical shape increasing in diameter in axial direction AD2. In an exemplary embodiment, surface 86 may comprise a linear portion and a conical or frusto-conical portion. Section 89 is arranged between shoulder 87 and end 92 and comprises radially outward facing surface 90. Radially outward facing surface 90 includes a substantially constant diameter. Tube 80 is arranged to be inserted, specifically with end 82 first, into connector body 40. Tube 80 is inserted into connector body 40 until section 83, or radially outward facing surface 84, engages seals 62A-62B (see FIG. 4). Shoulder 87 engages end 44, more specifically, surface 86 abuts against and/or engages end 44, at which point retainer 20 is assembled to secure tube 80 to connector body 40 (and service valve body 100), as will be described in greater detail below. It should be appreciated that tube 80 may be any traditional tube or tube end form comprising a bead, radially outward extending protrusion or flange, or ramp profile, which extends radially outward and axially on the outer surface of the tube, to secure the tube within the connector body. In an exemplary embodiment, tube 80 comprises a metal, a polymer, and/or a ceramic.

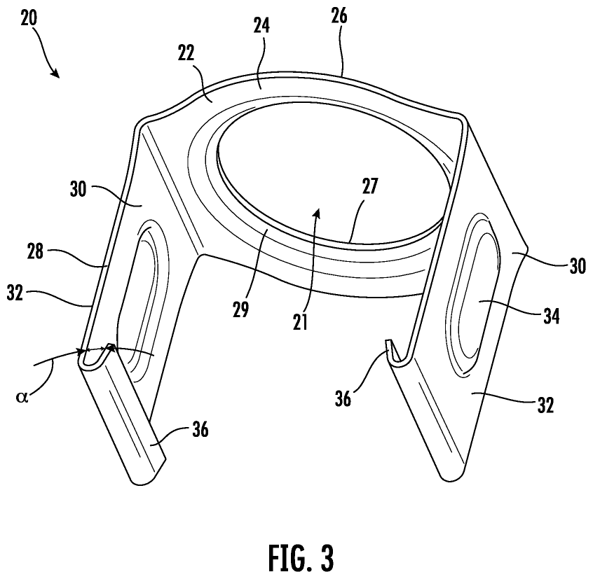

FIG. 3 is a rear perspective view of retainer 20. FIG. 4 is a cross-sectional view of fluid connection assembly 10 taken generally along line 4-4 in FIG. 1A. Retainer 20 generally comprises plate 22 and one or more arms 28 (e.g., two arms 28). Plate 22 comprises surface 24, surface 26, and through-bore 21 extending from surface 24 to surface 26. Through-bore 21 is operatively arranged to engage tube 80, specifically, section 89. In an exemplary embodiment, plate 22 further comprises raised portion 27 extending from surface 26 in axial direction AD2 forming recess 29 in surface 24. Recess 29 is operatively arranged to provide optimal engagement with shoulder 87 such that tube 80 is connected securely to connector body 40 (i.e., shoulder 87 is clamped tightly to end 44). In an exemplary embodiment, recess 29 and raised portion 27 are created by cold pressing or punching the portion of plate 22 immediately adjacent through-bore 21 in axial direction AD2. In an exemplary embodiment, raised portion 27 and/or recess 29 circumscribes through-bore 21.

Arms 28 comprise a proximal end connected to plate 22 and a distal end. Each of arms 28 comprises radially inward facing surface 30, radially outward facing surface 32, and projection 36. Projection 36 is arranged at the distal end of arm 28 and extends radially inward therefrom in radial direction RD1. Projection 36 is operatively arranged to engage groove 54 to secure retainer 20 to connector body 40 (see FIG. 4). In an exemplary embodiment, projection 36 comprises a hook. In an exemplary embodiment, and as best shown in FIG. 3, projection 36 is arranged at angle α with respect to radially inward facing surface 30. In an exemplary embodiment, angle α is an acute angle (e.g., 30 degrees).

Arms 28 are elastically deformable such that, during assembly of retainer 20 to connector body 40, arms 28 displace radially outward until projections 36 are aligned with groove 54, at which point arms 28 snap back radially inward to their original position. In an exemplary embodiment, arms 28 are arranged perpendicular to plate 22. In an exemplary embodiment, arms 28 further comprise protrusion or rib 34 extending radially outward from radially outward facing surface 32. Protrusion 34 provides added strength to arm 28. In an exemplary embodiment, retainer 20 is integrally formed (e.g., out of a single piece of sheet metal).

As shown in the figures, retainer 20 comprises two arms 28 circumferentially spaced about plate 22. In an exemplary embodiment, arms 28 are diametrically opposed, meaning the first arm 28 is arranged 180 degrees from the second arm 28, relative to through-bore 21 and plate 22. In an exemplary embodiment, radially inward facing surface 30 of arms 28 are arranged parallel to each other.

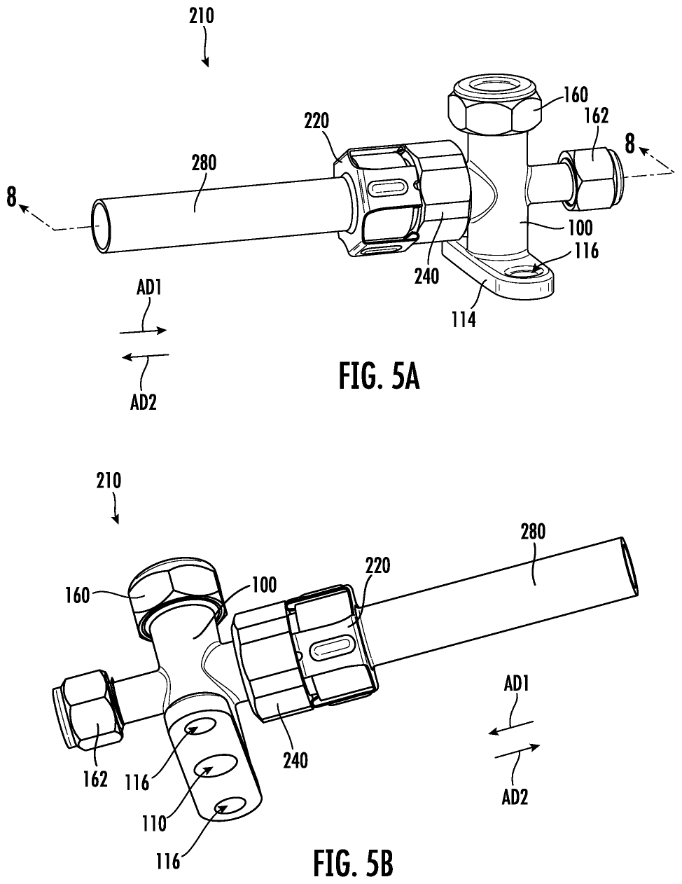

Service valve body 100 generally comprises section or tube 102, section or tube 118, and section or tube 130 to form a plurality of ports, for example, port 108, port 110, port 124, and port 136. Section 102, section 118, and section 130 are connected such that all ports 108, 110, 124, and 136 are in fluid communication. Section 102 comprises end 104 forming port 108 and end 106 forming port 110. In an exemplary embodiment, and as shown, port 108 and port 110 are concentrically aligned. In an exemplary embodiment, port 108 is a service port and may comprise a valve stem or a stop collar (retainer) arranged therein. In an exemplary embodiment, section 102 comprises threading 112 on its radially outward facing surface proximate end 104. In an exemplary embodiment, cap 160 is threadably engaged with threading 112 to seal port 108 (see FIGS. 5A-5B, 6, and 8). In an exemplary embodiment, port 110 is a middle port operatively arranged to be connected to a compressor or heat pump in a refrigeration system. In an exemplary embodiment, service valve body 100 comprises flange 114 connected to end 106. Flange 114 may comprise one or more through-holes 116 operatively arranged to secure service valve body 100 to another component (e.g., a compressor). In an exemplary embodiment, port 108 comprises a first diameter and port 110 comprises a second diameter, the second diameter being equal to the first diameter.

In an exemplary embodiment, port 108 comprises a first diameter and port 110 comprises a second diameter, the second diameter being nonequal to the first diameter.

Section 118 comprises end 122 connected to section 102 and end 120 forming port 124. In an exemplary embodiment, port 124 may be a valve port and thus comprise a valve therein (e.g., a Schroeder valve). The valve in port 124 may control fluid flow within service valve body 100, for example, between ports 108, 110, and 136. In an exemplary embodiment, section 118 comprises threading 126 on its radially outward facing surface proximate end 120. In an exemplary embodiment, cap 162 is threadably engaged with threading 126 to seal port 124 (see FIGS. 5A-5B, 6, and 8). In an exemplary embodiment, and as shown, port 124 is concentrically aligned with port 136. In an exemplary embodiment, section 118 is perpendicular to section 102. In an exemplary embodiment, section 118 is non-perpendicular to section 102.

Section 130 comprises end 134 connected to section 102 and end 132 forming port 136. In an exemplary embodiment, port 136 may be a line port and is operatively arranged to be connected to a component that is filled with fluid or through which fluid flows. For example, port 136 may be connected to a refrigerant line (i.e., tube 80, 280). In an exemplary embodiment, section 130 comprises threading 138 on its radially outward facing surface proximate end 132. In an exemplary embodiment, connector body 40, 240 is threadably engaged with threading 138, as will be described in greater detail below. In an exemplary embodiment, section 130 is perpendicular to section 102. In an exemplary embodiment, section 130 is non-perpendicular to section 102. In an exemplary embodiment, end 132 comprises a frusto-conical or curvilinear taper, wherein the diameter of the radially outward facing surface of section 130 decreases in axial direction AD2 (see FIG. 4). In an exemplary embodiment, port 124 comprises a first diameter and port 136 comprises a second diameter, the second diameter being greater than the first diameter. In an exemplary embodiment, port 124 comprises a first diameter and port 136 comprises a second diameter, the second diameter being less than or equal to the first diameter.

Connector body 40 comprises through-bore 41 extending from end 42 to end 44, radially inward facing surface 46, one or more grooves (e.g., grooves 50A-50B), radially outward facing surface 52, groove 54, head 58, and radially inward facing surface 56. Connector body 40 is arranged to be removably and sealingly connected to service valve body 100. Connector body 40 may be screwed onto a service valve body 100, specifically, by threadably engaging threading 60 on radially inward facing surface 56 with threading 138 of section 130. Connector body 40 may be screwed onto section 130 via head 58 (e.g., using a wrench, socket, gator grip, etc.). In an exemplary embodiment, head 58 is hexagonal; however, it should be appreciated that head 58 may comprise any geometry suitable for applying torque to connector body 40. It should be appreciated that fluid connection assembly 10 may be used in various components, assemblies, and subassemblies in which fluid connection is desired, for example, refrigeration systems or compressors, or a transmission. In an exemplary embodiment, connector body 40 and service valve body 100 are integrally formed.

End 42 is connected to section 130. Connector body 40 is arranged to be connected to a component that is filled with a fluid or through which fluid flows. For example, connector body 40 may be connected to a refrigerant line (i.e., tube 80). Seals 62A-62B are arranged in connector body 40. Specifically, seals 62A-62B are arranged in grooves 50A-50B to engage tube 80 (i.e., radially outward facing surface 84). Grooves 50A-50B are arranged spaced apart axially in radially inward facing surface 46. In an exemplary embodiment, seals 62A-62B are O-rings. In an exemplary embodiment, connector body 40 only comprises one groove in its radially inward facing surface 46, and one seal arranged therein. In an exemplary embodiment, radially inward facing surface 46 is a substantially cylindrical surface. End 44 is operatively arranged to engage shoulder 87, specifically, to prevent axial displacement of tube 80 is axial direction AD1.

In an exemplary embodiment, and as shown, connector body 40 comprises projection 48, which extends radially inward in radial direction RD1 from radially inward facing surface 46. Projection 48 is connected to radially inward facing surface 46 via surface 47. In an exemplary embodiment, surface 47 is a substantially axial facing surface and faces axial direction AD2. In an exemplary embodiment, surface 47 acts as a stop or seat for tube 80 thereby preventing tube 80 from being displaced in axial direction AD1 with respect to connector body 40. In an exemplary embodiment, and as shown, connector body 40 further comprises radially inward facing surface 49 which connects projection 48 with radially inward facing surface 56. Radially inward facing surface 49 acts as a stop or seat for section 130. In an exemplary embodiment, the (frusto-conical) surface of end 132 creates a metal to metal seal with surface 49. In an exemplary embodiment, radially inward facing surface 49 is a frusto-conical surface that increases in diameter in axial direction AD1 (see FIG. 4). In an exemplary embodiment, radially inward facing surface 56 comprises a diameter that is greater than the diameter of radially inward facing surface 46. In an exemplary embodiment, radially inward facing surface 56 comprises a diameter that is less than or equal to the diameter of radially inward facing surface 46.

Groove 54 is arranged in radially outward facing surface 52. Groove 54 is arranged axially between and spaced apart from end 44 and end 42. Groove 54 comprises a radially outward facing surface and two axial facing surfaces. The radially outward facing surface of groove 54 comprises a diameter that is less than the diameter of radially outward facing surface 52. In an exemplary embodiment, groove 54 is arranged axially between and spaced apart from end 44 and head 58. In an exemplary embodiment, and as shown, groove 54 is arranged immediately adjacent head 58. Groove 54 is operatively arranged to engage with projections 36 to connect retainer 20 to connector body 40. In an exemplary embodiment, connector body 40 comprises a metal, a polymer, and/or a ceramic.

To assemble fluid connection assembly 10, connector body 40 is connected to service valve body 100, specifically, section 130. For example, connector body 40 may be screwed onto section 130 such that threading 60 is engaged with threading 138. In an exemplary embodiment, end 132 (or its frusto-conical taper) is engaged with radially inward facing surface 49. In an exemplary embodiment, end 132 is spaced apart from radially inward facing surface 49. Tube 80 is inserted in axial direction AD1, with end 82 first, into connector body 40. Radially outward facing surface 84 engages seals 62A-62B and section 83 is arranged inside of connector body 40 proximate or adjacent to radially inward facing surface 46. Shoulder 87 engages end 44 of connector body 40, specifically, surface 86 abuts against end 44. In an exemplary embodiment, and as shown, shoulder 87 resides completely outside of connector body 40. In an exemplary embodiment, end 82 abuts against surface 47. In an exemplary embodiment, end 82 is spaced apart from surface 47.

Retainer 20 is then secured over both tube 80 and connector body 40. Specifically, through-bore 21 is aligned with section 89. Plate 22 is engaged with radially outward facing surface 90 and retainer 20 is displaced along tube 80 in axial direction AD1. Projections 36 engage radially outward facing surface 52 thereby displacing arms 28 radially outward. Once projections 36 are aligned with groove 54, arms 28 displace radially inward to their original position, forming the locked state. Additionally, in an exemplary embodiment, through-bore 21 comprises a first diameter and radially outward facing surface 90 comprises a second diameter being substantially similar to or just less than the first diameter. As such, plate 22 engages tube 80, specifically radially outward facing surface 90, thereby preventing the ingress of foreign materials into fluid connection assembly 10.

In locked state: 1) plate 22 engages shoulder 87 (e.g., surface 24 and/or recess 29 engages surface 88); 2) shoulder 87 engages end 44 (e.g., surface 86 abuts against end 44); 3) arms 28 engage radially outward facing surface 52 (e.g., radially inward facing surfaces 30 abut against radially outward facing surface 52); and/or 4) projections 36 engage groove 54. The engagement of tube 80 with connector body 40 prevents axial displacement of tube 80 in axial direction AD1 and the engagement of retainer 20 with connector body 40 and tube 80 prevents axial displacement of tube 80 in axial direction AD2, as well as radial directions RD1 and RD2, relative to connector body 40.

To disassemble, arms 28 are displaced radially outward until projections 36 disengage groove 54. Then retainer 20 and/or tube 80 can be removed from connector body 40. For example, first retainer 20 can be removed from tube 80 and then tube 80 can be removed from connector body 40. Alternatively, tube 80 can be removed from connector body 40 with retainer 20 still arranged on section 89.

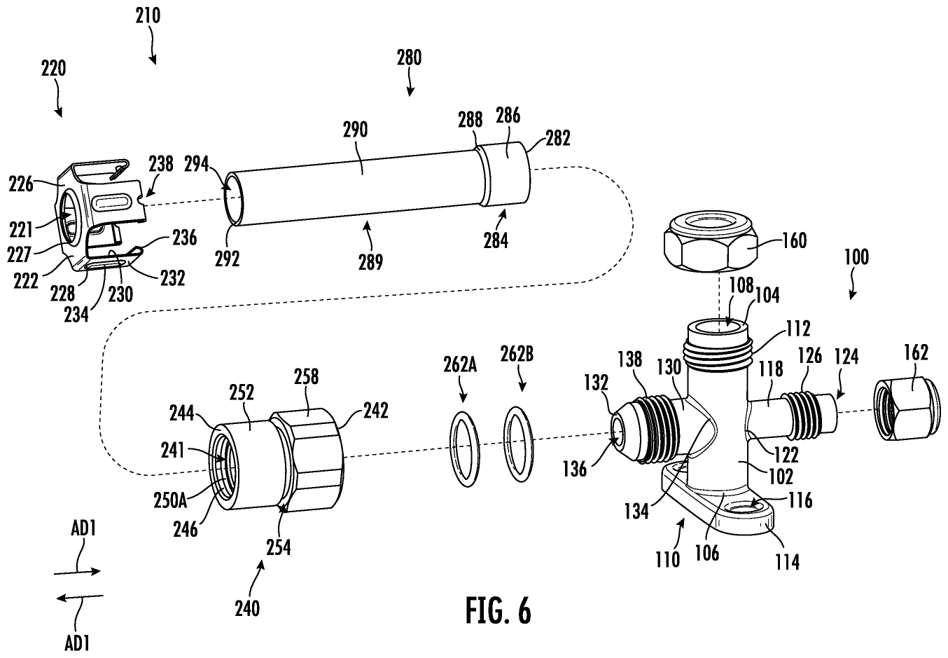

FIG. 5A is a front perspective view of fluid connection assembly 210 in a locked state. FIG. 5B is a rear perspective view of fluid connection assembly 210. FIG. 6 is a front perspective exploded view of the fluid connection assembly shown in FIG. 5A. Fluid connection assembly 210 generally comprises connector body 240 and retainer 220. In an exemplary embodiment, fluid connection assembly 210 further comprises tube 280. In an exemplary embodiment, fluid connection assembly 210 further comprises service valve body 100.

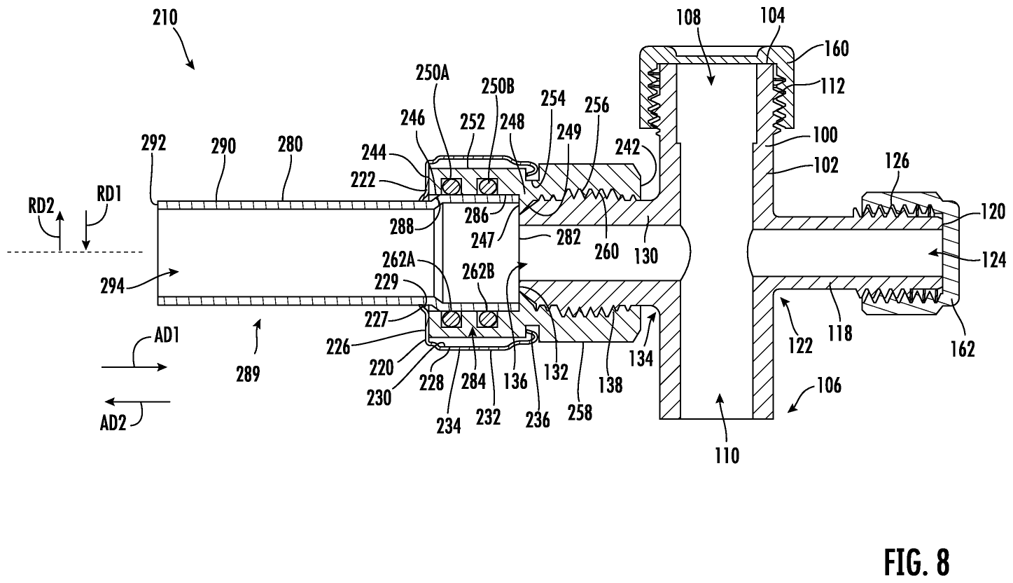

Tube 280 comprises end 282, flared section 284, shoulder or surface 288, section 289, end 292, and through-bore 294. Through-bore 294 extends through tube 280 from end 282 to end 292. Flared section 284 is arranged between end 282 and surface 288 and comprises radially outward facing surface 286. Radially outward facing surface 286 includes a substantially constant diameter. In an exemplary embodiment, radially outward facing surface 286 comprises a frusto-conical taper or curvilinear surface proximate end 282. Surface 288 is arranged between flared section 284 and section 289. In an exemplary embodiment, surface 288 is an axial surface facing at least partially in axial direction AD2. In an exemplary embodiment, surface 288 is a frusto-conical surface extending from radially outward facing surface 286 to radially outward facing surface 290 radially inward in axial direction AD2. For example, surface 288 may be a linear conical shape increasing in diameter in axial direction AD1 (see FIG. 8). In an exemplary embodiment, surface 288 may comprise a linear portion and a conical or frusto-conical portion.

Section 289 is arranged between surface 288 and end 292 and comprises radially outward facing surface 290. Radially outward facing surface 290 includes a substantially constant diameter. In an exemplary embodiment, the diameter of radially outward facing surface 290 is less than the diameter of radially outward facing surface 286. In an exemplary embodiment, the diameter of the radially inward facing surface of section 289 is less than the diameter of the radially inward facing surface of flared section 284. Tube 280 is arranged to be inserted, specifically with end 282 first, into connector body 240. Tube 280 is inserted into connector body 240 until section 284, or radially outward facing surface 286, engages seals 262A-262B (see FIG. 8). Flared section 284 is arranged completely within connector body 240. End 282 engages surface 247 of protrusion 248, at which point retainer 220 is assembled to secure tube 280 to connector body 240 (and service valve body 100), as will be described in greater detail below. It should be appreciated that tube 280 may be any traditional tube or tube end form comprising a bead, radially outward extending protrusion or flange, or ramp profile, which extends radially outward and axially on the outer surface of the tube, to secure the tube within the connector body. In an exemplary embodiment, tube 280 comprises a metal, a polymer, and/or a ceramic.

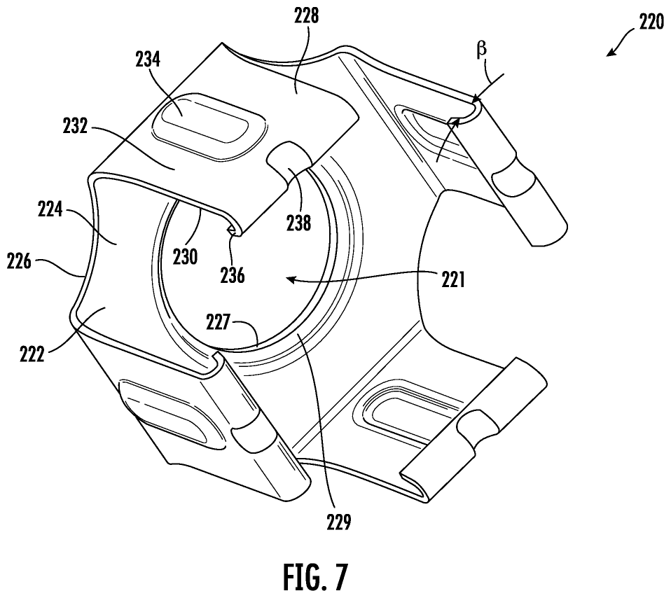

FIG. 7 is a rear perspective view of retainer 220. FIG. 8 is a cross-sectional view of fluid connection assembly 210 taken generally along line 8-8 in FIG. 5A. Retainer 220 generally comprises plate 222 and one or more arms 228 (e.g., four arms 228). Plate 222 comprises surface 224, surface 226, and through-bore 221 extending from surface 224 to surface 226. Through-bore 221 is operatively arranged to engage tube 280, specifically, section 289. In an exemplary embodiment, plate 222 further comprises raised portion 227 extending from surface 226 in axial direction AD2 forming recess 229 in surface 224. Recess 229 is operatively arranged to provide optimal engagement with surface 288 such that tube 280 is connected securely to connector body 240 (i.e., radially outward facing surface 286 is engaged with seals 262A-262B and flared section 284 remains within connector body 240). In an exemplary embodiment, recess 229 and raised portion 227 are created by cold pressing or punching the portion of plate 222 immediately adjacent through-bore 221 in axial direction AD2. In an exemplary embodiment, raised portion 227 and/or recess 229 circumscribes through-bore 221.

Arms 228 comprise a proximal end connected to plate 222 and a distal end. Each of arms 228 comprises radially inward facing surface 230, radially outward facing surface 232, and projection 236. Projection 236 is arranged at the distal end of arm 228 and extends radially inward therefrom in radial direction RD1. Projection 236 is operatively arranged to engage groove 254 to secure retainer 220 to connector body 240 (see FIG. 8). In an exemplary embodiment, projection 236 comprises a hook. In an exemplary embodiment, and as best shown in FIG. 7, projection 236 is arranged at angle β with respect to radially inward facing surface 230. In an exemplary embodiment, angle β is an acute angle (e.g., 30 degrees). In an exemplary embodiment, the distal end of arms 228 further comprise indentation 238 extending into projection 236 in axial direction AD2. Indentation 238 increases the strength and rigidity of projection 236. In an exemplary embodiment, indentation 238 is created by cold pressing or punching arm 228 after projection 236 is formed thereon.

Arms 228 are elastically deformable such that, during assembly of retainer 220 to connector body 240, arms 228 displace radially outward until projections 236 are aligned with groove 254, at which point arms 228 snap back radially inward to their original position. In an exemplary embodiment, arms 228 are arranged perpendicular to plate 222. In an exemplary embodiment, arms 228 further comprise protrusion or rib 234 extending radially outward from radially outward facing surface 232. Protrusion 234 provides added strength to arm 228. In an exemplary embodiment, retainer 220 is integrally formed (e.g., out of a single piece of sheet metal).

As shown in the figures, retainer 220 comprises four arms 228 circumferentially spaced about plate 222. In an exemplary embodiment, in order in a circumferential direction about a center axis of through-bore 221, the first arm and third arm are diametrically opposed and the second arm and the fourth arm are diametrically opposed. In an exemplary embodiment, radially inward facing surface 230 of first and third arms 228 are arranged parallel to each other and/or radially inward facing surface 230 of second and fourth arms 228 are arranged parallel to each other. In an exemplary embodiment, the first arm 228 and the second arm are arranged perpendicular to each other, and the third arm 228 and the second arm are arranged perpendicular to each other.

Connector body 240 comprises through-bore 241 extending from end 242 to end 244, radially inward facing surface 246, one or more grooves (e.g., grooves 250A-250B), radially outward facing surface 252, groove 254, head 258, and radially inward facing surface 256. Connector body 240 is arranged to be removably and sealingly connected to service valve body 100. Connector body 240 may be screwed onto a service valve body 100, specifically, by threadably engaging threading 260 on radially inward facing surface 256 with threading 138 of section 130. Connector body 240 may be screwed onto section 130 via head 258 (e.g., using a wrench). In an exemplary embodiment, head 258 is hexagonal; however, it should be appreciated that head 258 may comprise any geometry suitable for applying torque to connector body 240. It should be appreciated that fluid connection assembly 210 may be used in various components, assemblies, and subassemblies in which fluid connection is desired, for example, refrigeration systems or compressors, or a transmission. In an exemplary embodiment, connector body 240 and service valve body 100 are integrally formed.

End 242 is connected to section 130. Connector body 240 is arranged to be connected to a component that is filled with a fluid or through which fluid flows. For example, connector body 240 may be connected to a refrigerant line (i.e., tube 280). Seals 262A-262B are arranged in connector body 240. Specifically, seals 262A-262B are arranged in grooves 250A-250B to engage tube 280 (i.e., radially outward facing surface 286). Grooves 250A-250B are arranged spaced apart axially in radially inward facing surface 246. In an exemplary embodiment, seals 262A-262B are O-rings. In an exemplary embodiment, connector body 240 only comprises one groove in its radially inward facing surface 246, and one seal arranged therein. In an exemplary embodiment, radially inward facing surface 246 is a substantially cylindrical surface.

In an exemplary embodiment, and as shown, connector body 240 comprises projection 248, which extends radially inward in radial direction RD1 from radially inward facing surface 246. Projection 248 is connected to radially inward facing surface 246 via surface 247. In an exemplary embodiment, surface 247 is a substantially axial facing surface and faces axial direction AD2. In an exemplary embodiment, surface 247 acts as a stop or seat for tube 280 thereby preventing tube 280 from being displaced in axial direction AD1 with respect to connector body 240. In an exemplary embodiment, and as shown, connector body 240 further comprises radially inward facing surface 249 which connects projection 48 with radially inward facing surface 56. Radially inward facing surface 249 acts as a stop or seat for section 130. In an exemplary embodiment, radially inward facing surface 249 is a frusto-conical surface that increases in diameter in axial direction AD1 (see FIG. 8). In an exemplary embodiment, radially inward facing surface 256 comprises a diameter that is greater than the diameter of radially inward facing surface 246. In an exemplary embodiment, radially inward facing surface 256 comprises a diameter that is less than or equal to the diameter of radially inward facing surface 46.

Groove 254 is arranged in radially outward facing surface 252. Groove 254 is arranged axially between and spaced apart from end 244 and end 242. Groove 254 comprises a radially outward facing surface and two axial facing surfaces. The radially outward facing surface of groove 254 comprises a diameter that is less than the diameter of radially outward facing surface 252. In an exemplary embodiment, groove 254 is arranged axially between and spaced apart from end 244 and head 258. In an exemplary embodiment, and as shown, groove 254 is arranged immediately adjacent head 258. Groove 254 is operatively arranged to engage with projections 236 to connect retainer 220 to connector body 240. In an exemplary embodiment, connector body 240 comprises a metal, a polymer, and/or a ceramic.

To assemble fluid connection assembly 210, connector body 240 is connected to service valve body 100, specifically, section 130. For example, connector body 240 may be screwed onto section 130 such that threading 260 is engaged with threading 138. In an exemplary embodiment, end 132 (or its frusto-conical taper) is engaged with radially inward facing surface 249. In an exemplary embodiment, end 132 is spaced apart from radially inward facing surface 249. Tube 280 is inserted in axial direction AD1, with end 282 first, into connector body 240. Radially outward facing surface 286 engages seals 262A-262B and flared section 284 is arranged completely inside of connector body 240 proximate or adjacent to radially inward facing surface 246. In an exemplary embodiment, surface 282 engages and/or abuts against surface 247 of connector body 240. In an exemplary embodiment, end 282 is spaced apart from surface 247.

Retainer 220 is then secured over both tube 280 and connector body 240. Specifically, through-bore 221 is aligned with section 289. Plate 222 is engaged with radially outward facing surface 290 and retainer 220 is displaced along tube 280 in axial direction AD1. Projections 236 engage radially outward facing surface 252 thereby displacing arms 228 radially outward. Once projections 236 are aligned with groove 254, arms 228 displace radially inward to their original position, forming the locked state. Additionally, in an exemplary embodiment, through-bore 221 comprises a first diameter and radially outward facing surface 290 comprises a second diameter being substantially similar to or just less than the first diameter. As such, plate 222 engages tube 280, specifically radially outward facing surface 290, thereby preventing the ingress of foreign materials into fluid connection assembly 210.

In locked state: 1) plate 222 engages surface 288 (e.g., surface 224 and/or recess 229 engages surface 288); 2) end 282 engages surface 247 (e.g., surface 282 abuts against surface 247); 3) arms 228 engage radially outward facing surface 252 (e.g., radially inward facing surfaces 230 abut against or are arranged proximate to radially outward facing surface 252); and/or 4) projections 236 engage groove 254. The engagement of tube 280 with connector body 240 prevents axial displacement of tube 280 in axial direction AD1 and the engagement of retainer 220 with connector body 240 and tube 280 prevents axial displacement of tube 280 in axial direction AD2, as well as radial directions RD1 and RD2, relative to connector body 240.

To disassemble, arms 228 are displaced radially outward until projections 236 disengage groove 254. Then retainer 220 and/or tube 280 can be removed from connector body 240. For example, first retainer 220 can be removed from tube 280 and then tube 280 can be removed from connector body 240. Alternatively, tube 280 can be removed from connector body 240 with retainer 220 still arranged on section 289.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Fluid connection assembly
20 Retainer
21 Through-bore
22 Plate
24 Surface
26 Surface
27 Raised portion
28 Arm
29 Recess
30 Radially inward facing surface
32 Radially outward facing surface
34 Protrusion
36 Projection
40 Connector body
41 Through-bore
42 End
44 End
46 Radially inward facing surface
47 Axial surface or seat
48 Projection
49 Axial surface or seat
50A Groove
50B Groove
52 Radially outward facing surface
54 Groove
56 Radially inward facing surface
58 Head
60 Threading
62A Seal
62B Seal
80 Tube
82 End
83 Section
84 Radially outward facing surface
86 Surface
87 Shoulder or bead
88 Surface
89 Section
90 Radially outward facing surface
92 End
94 Through-bore
100 Service valve body
102 Section or tube
104 End
106 End
108 Port or service port
110 Port or middle port
112 Threading
114 Flange
116 Hole(s)
118 Section or tube
120 End
122 End
124 Port or valve port
126 Threading
130 Section or tube
132 End
134 End
136 Port or line port
138 Threading
160 Cap
162 Cap
210 Fluid connection assembly
220 Retainer
221 Through-bore
222 Plate
224 Surface
226 Surface
227 Raised portion
228 Arm
229 Recess
230 Radially inward facing surface
232 Radially outward facing surface
234 Protrusion
236 Projection
238 Indentation
240 Connector body
241 Through-bore
242 End
244 End
246 Radially inward facing surface
247 Axial surface or seat
248 Projection
249 Axial surface or seat
250A Groove
250B Groove
252 Radially outward facing surface
254 Groove
256 Radially inward facing surface
258 Head
260 Threading
262A Seal
262B Seal
280 Tube
282 End
284 Section
286 Radially outward facing surface
288 Surface
289 Section
290 Radially outward facing surface
292 End
294 Through-bore
AD1 Axial direction
AD2 Axial direction
RD1 Radial direction
RD2 Radial direction
α Angle
β Angle

What is claimed is:

1. A fluid connection assembly, comprising:
a connector body, including:
a first end;
a second end;
a first through-bore;
a first radially outward facing surface including a groove; and
a first radially inward facing surface; and
a retainer, including:
a plate including a second through-bore;
at least one arm, each arm of the at least one arm including a proximal end connected to the plate and a distal end; and
a projection connected to the at least one arm at the distal end, the projection operatively arranged to engage the groove to connect the retainer to the connector body.

2. The fluid connection assembly as recited in claim 1, wherein at least one arm of the at least one arm further comprises:
a second radially inward facing surface operatively arranged to engage the first radially outward facing surface;
a second radially outward facing surface; and
a rib extending radially from at least one of the second radially inward facing surface and the second radially outward facing surface.

3. The fluid connection assembly as recited in claim 2, wherein the projection extends radially inward from the second radially inward facing surface.

4. The fluid connection assembly as recited in claim 3, wherein the projection is arranged at an acute angle relative to the second radially inward facing surface.

5. The fluid connection assembly as recited in claim 1, wherein the plate comprises a recess circumscribing the second through-bore.

6. The fluid connection assembly as recited in claim 1, wherein the at least one arm comprises:
a first arm; and
a second arm arranged diametrically opposed to the first arm relative to the plate.

7. The fluid connection assembly as recited in claim 1, wherein the at least one arm is elastically deformable in a radial direction.

8. The fluid connection assembly as recited in claim 1, wherein:
the connector body further comprises a protrusion extending radially inward from the first radially inward facing surface;
the protrusion forms a first surface and a second surface; and
the first surface is an axially facing surface arranged perpendicular to the first radially inward facing surface.

9. The fluid connection assembly as recited in claim 8, wherein the second surface is a frusto-conical surface.

10. The fluid connection assembly as recited in claim 8, further comprising a tube including a shoulder, wherein the plate is operatively arranged to engage the shoulder to secure the tube to the connector body.

11. The fluid connection assembly as recited in claim 10, wherein the tube comprises a flared section forming the shoulder, the flared section arranged completely within the first through-bore when the tube is secured to the connector body.

12. The fluid connection assembly as recited in claim 10, wherein the shoulder is arranged to abut against the second end.

13. The fluid connection assembly as recited in claim 1, wherein the at least one arm further comprises an indentation extending axially from the distal end.

14. The fluid connection assembly as recited in claim 1, wherein the at least one arm comprises:
a first arm;
a second arm arranged diametrically opposed to the first arm relative to the plate;
a third arm; and
a fourth arm arranged diametrically opposed to the third arm relative to the plate.

15. The fluid connection assembly as recited in claim 1, wherein the first end is arranged to be sealingly secured to a service valve body.

16. A fluid connection assembly, comprising:
a connector body, including:
a first end;
a second end;
a first through-bore;
a first radially outward facing surface including a groove;
a first radially inward facing surface; and
a protrusion extending radially inward from the first radially inward facing surface;
a tube including a shoulder operatively arranged to be inserted into the first through-bore; and
a retainer, including:
a plate including a second through-bore, the plate operatively arranged to engage the shoulder to secured the tube in the connector body;
a plurality of arms, each arm of the plurality of arms including a proximal end connected to the plate and a distal end; and
a projection connected to the at least one arm at the distal end, the projection operatively arranged to engage the groove to connect the retainer to the connector body.

17. The fluid connection assembly as recited in claim 16, wherein at least one arm of the plurality of arms further comprises:
a second radially inward facing surface operatively arranged to engage the first radially outward facing surface;
a second radially outward facing surface; and
a rib extending radially from at least one of the second radially inward facing surface and the second radially outward facing surface.

18. The fluid connection assembly as recited in claim 17, wherein the projection extends radially inward from the second radially inward facing surface and is arranged at an acute angle relative to the second radially inward facing surface.

19. The fluid connection assembly as recited in claim 16, wherein the plate comprises a recess circumscribing the second through-bore.

20. A retainer for a fluid connection assembly, comprising:
a plate including a through-bore;
a first arm connected to and extending from the plate;
a second arm connected to and extending from the plate, the second arm arranged diametrically opposed to the first arm relative to the plate;
a projection connected to and extending radially inward from at least one of the first arm and the second arm; and
a rib extending radially from at least one of the first arm and the second arm.
